(19) United States
(12) Patent Application Publication
(10) Pub. No.: US 2009/0312866 A1
(43) Pub. Date: Dec. 17, 2009

(54) DISPLAY APPARATUS FOR VENDING MACHINE, VENDING MACHINE AND CONTROL METHOD WITH THE SAME

(75) Inventors: Kwang-won KIM, Seoul (KR); Seung-kee CHO, Anyang-si (KR); Dae-hyuck IM, Gunpo-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/349,532

(22) Filed: Jan. 7, 2009

(30) Foreign Application Priority Data
Jun. 12, 2008 (KR) 10-2008-0055441

(51) Int. Cl. G06F 17/00; G07F 11/00; G06F 3/041

(52) U.S. Cl. 700/231; 221/9; 345/173

(57) ABSTRACT

A display apparatus for a vending machine that has a goods storage to store a plurality of goods, and an outlet to accommodate the goods, which are discharged from the goods storage, to be taken out, the display apparatus includes: an input part through which a plurality of goods is selected to be discharged together; a display unit which displays information and quantity of the selected goods; and a controller which controls the selected goods to be discharged from the goods storage to the outlet based on the information and the quantity of the selected goods.

### CROSS-REFERENCE TO RELATED APPLICATION

This application claims priority from Korean Patent Application No. 10-2008-0055441, filed on Jun. 12, 2008 in the Korean Intellectual Property Office, the disclosure of which is incorporated herein by reference.

### BACKGROUND OF INVENTION

1. Field of Invention

Apparatuses and methods consistent with the present invention relate to a vending machine, and more particularly to a display apparatus for a vending machine, a vending machine and a control method with the same, which are improved in a manner of selecting and discharging goods.

2. Description of the Related Art

In general, a vending machine stores various kinds of goods and allows a consumer to selectively buy the goods corresponding to the amount of money inserted.

Recently, the vending machine has diversified the goods, e.g., a snack or the like stored therein without being limited to coffee or a can beverage. The vending machine is advantageous to reduce labor costs and the like since there is no need of a salesman. Accordingly, use of the vending machine tends to increase gradually.

However, such a related art vending machine is configured not to allow a consumer to select and take out the goods until another one of the goods previously selected by him/her is taken out, so that he/she may spend a long time to take out the plural goods. Like this, if time to vend the goods is increased due to the long time required for taking out the goods, a consumer has to spend more time in buying the goods and thus may give up the buy, thereby causing a drop in sales.

### SUMMARY OF THE INVENTION

Accordingly, it is an aspect of the present invention to provide a display apparatus for a vending machine, a vending machine and a control method with the same, in which a plurality of goods can be selected to be discharged together.

Another aspect of the present invention is to provide a display apparatus for a vending machine, a vending machine and a control method with the same, in which a plurality of goods can be discharged at once.

Still another aspect of the present invention is to provide a display apparatus for a vending machine, a vending machine and a control method with the same, in which a quantity of goods to be discharged at once can be limited.

The foregoing and/or other aspects of the present invention can be achieved by providing a display apparatus for a vending machine that has a goods storage to store a plurality of goods, and an outlet to discharge selected goods which are selected from the plurality of goods in the goods storage, the display apparatus including: an input part through which the selected goods are selected to be discharged together; a display unit which displays information and quantity of the selected goods; and a controller which controls the goods storage to discharge the selected goods to the outlet based on the information and the quantity of the selected goods.

The controller may control the display unit to display a goods selection menu to select the selected goods to be discharged, and a quantity setting menu to set the quantity of the selected goods selected through the goods selection menu.

The controller may control the display unit to display a recommendation menu for recommending suggested goods from the plurality of goods according to an amount of money inserted.

In the recommendation menu, the controller may control the display unit to display a list of goods from the plurality of goods in order of leaving less change with respect to the amount of money inserted.

The controller may limit a discharge quantity of the selected goods to be discharged together, which can be discharged from the goods storage to the outlet at once.

Based on a reference quantity of goods to be discharged at once, the controller may control the discharge quantity of the selected goods to be discharged at once to be equal to or less than the reference quantity.

Based on a weighted value for each good of the plurality of goods and a reference weighted value previously set to be discharged at once, the controller may control a total weighted value of the selected goods to be dischargeable at once to be equal to or less than the reference weighted value.

The information of the selected goods may include at least one of icons and names corresponding to the selected goods.

The display unit may be a flat panel display, and the input part includes a touch panel.

The display unit and the input part are formed as a single body.

The selected goods selected by the input part may include a plurality of one kind of goods.

The selected goods selected by the input part may include at least one from each of plural kinds of goods.

The controller may calculate a purchasable quantity of goods which can be selected with respect to each of the goods of the plurality of goods, in consideration of an amount of money inserted, and control the display unit to display the purchasable quantity of goods calculated by the controller.

The controller may calculate a remainder quantity of goods which can be additionally selected in consideration of an amount of money remaining after at least one of the goods is selected.

Another aspect of the present invention can be achieved by providing a vending machine including: a goods storage which stores a plurality of goods; an outlet which discharges selected goods, selected from the plurality of goods, from the goods storage; an input part through which the selected goods are selected to be discharged together; a display unit which displays information and quantity of the selected goods; and a controller which controls the goods storage to discharge the selected goods to the outlet based on the information and the quantity of the selected goods.

The controller may control the display unit to display a goods selection menu to select the selected goods to be discharged, and a quantity setting menu to set the quantity of the selected goods selected through the goods selection menu.

The vending machine may further include a discharging passage which is provided between the goods storage and the outlet and through which the selected goods are discharged at once.

The vending machine may further include a plurality of discharging passages which are provided between the goods storage and the outlet and through which the selected goods are discharged at once.

The information of the selected goods may include at least one of icons and names corresponding to the goods.

The display may include a flat panel display, and the input part may include a touch panel.

The display unit and the input part may be formed as a single body.

The selected goods selected by the input part may include a plurality of one kind of good.

The selected goods selected by the input part may include at least one from each of plural kinds of goods.

The controller may calculate a purchasable quantity of goods which can be selected, with respect to each of the goods of the plurality of goods, in consideration of an amount of money inserted, and control the display unit to display the purchasable quantity of goods calculated by the controller.

Still another aspect of the present invention may be achieved by providing a method of controlling a display apparatus for a vending machine that has a goods storage to store a plurality of goods, and an outlet to discharge selected goods from the goods storage, the method including: displaying the plurality of goods, wherein the plurality of goods are selectable; selecting the selected goods to be dischargeable together; displaying information and quantity of the selected goods; and controlling the goods storage to discharge the selected goods to the outlet based on the information and the quantity of the selected goods.

The method may further include displaying a goods selection menu to select the selected of goods to be discharged, and a quantity setting menu to set the quantity of the selected goods selected through the goods selection menu.

The method may further include displaying a recommendation menu for recommending suggested goods from the plurality of goods according to an amount of money inserted.

The method may further include displaying a list of goods from the plurality of goods in order of leaving less change with respect to the amount of money inserted, in the recommendation mode menu.

The method may further include detecting a total quantity of discharged goods discharged from the goods storage, and displaying the goods listed in order of most discharged, if the list of goods includes selectable goods which leave a same amount of change.

The method may further include limiting a discharge quantity of the selected goods to be discharged together, which can be discharged from the goods storage to the outlet at once.

The method may further include controlling the discharge quantity to be equal to or less than a reference quantity based on the reference quantity of goods to be discharged at once.

The method may further include controlling a total weighted value of the selected goods to be dischargeable at once to be equal to or less than a reference weighted value based on a weighted value for each good of the plurality of goods, and the reference weighted value for a total quantity of goods to be discharged at once.

Yet another aspect of the present invention can be achieved by providing a method of controlling a vending machine with a display unit having a touch-screen function, the method including: displaying a plurality of goods, wherein the plurality of goods are selectable; selecting selected goods to be dischargeable together; displaying information and quantity of the selected goods; and controlling the selected goods to be discharged from the goods storage to the outlet based on the information and the quantity of the selected goods.

The method may further include displaying a goods selection menu to select the selected goods to be discharged, and a quantity setting menu to set the quantity of the selected goods selected through the goods selection menu.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a perspective view of a vending machine according to an exemplary embodiment of the present invention;

FIG. 2A is a perspective view of the vending machine according to an exemplary embodiment of the present invention, of which a door is opened;

FIG. 2B is a perspective view of the vending machine according to another exemplary embodiment of the present invention, of which a door is opened;

FIG. 3 is a control block diagram of a vending machine according to an exemplary embodiment of the present invention;

FIG. 4 shows a user input mode on a display unit of a display apparatus for a vending machine according to an exemplary embodiment of the present invention;

FIG. 5 shows a recommendation mode on a display unit of a display apparatus for a vending machine according to an exemplary embodiment of the present invention; and

FIGS. 6 through 11 are control flowcharts of the vending machine and the display apparatus for the vending machine according to exemplary embodiments of the present invention, respectively.

### DETAILED DESCRIPTION OF EXEMPLARY EMBODIMENTS OF THE INVENTION

Below, embodiments of the present invention will be described in detail with reference to accompanying drawings, in which like reference numerals refer to like elements throughout and they may be described once in a representative exemplary embodiment to avoid repetitive description.

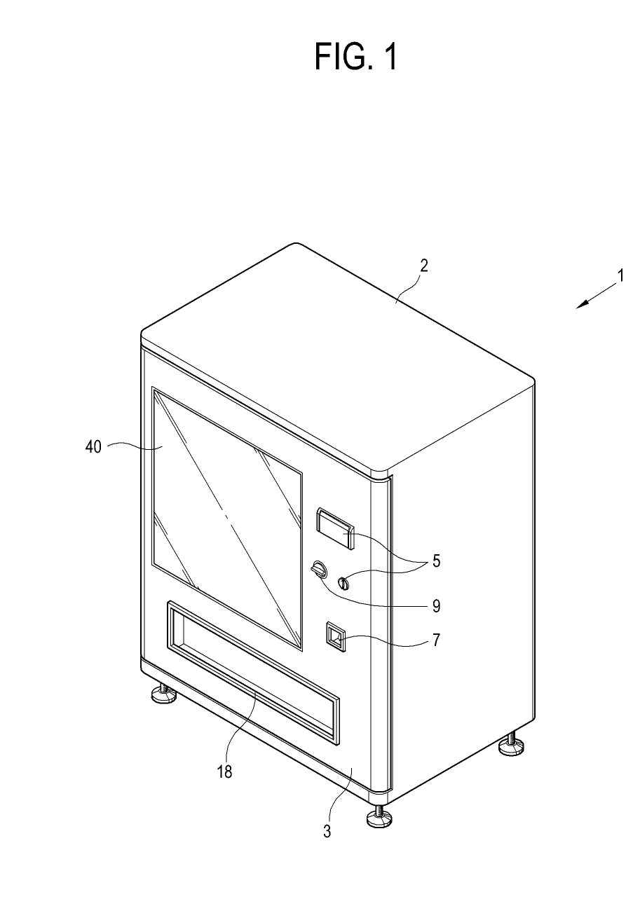

As shown in FIGS. 1 through 3, a vending machine 1 according to an exemplary embodiment of the present invention includes a main body 2 and a door 3 to be opened and closed with respect to the main body 2. In more detail, the vending machine 1 includes a goods-storage 10 to store a plurality of goods; a outlet 14 to discharge the goods from the goods storage 10; an input part 30 allowing a user to select the plurality of goods to be discharged together; a display unit 40 to display the information and the number of the selected goods; and a controller 70 to control the goods storage 10 to discharge the goods to the outlet 14 according to the information and the number of the selected goods.

For example, the door 3 includes a money slot 5 into which money is inserted, a return button 9 to return the money inserted, a return part 7 where the returned money is taken out. Further, the door 3 is provided with a taking-out opening 18 communicating with the outlet 14 and allowing a user to take out the goods discharged to the outlet 14. Also, the money slot 5 may be connected with a money scanner (not shown) to scan a sum of money inserted and transmit scanned information about the sum of money inserted to the controller 70. Such a configuration such as the money slot 5, the money scanner (not shown), etc. has been known publicly, and thus detailed descriptions thereof will be omitted.

The goods storage 10 is provided inside the main body 2 so as to store various kinds of goods. For example, the goods storage 10 includes a plurality of stacks 11 arranged in left and right directions, where the plurality of goods can be stacked vertically. However, the goods storage 10 is not limited thereto, and may be provided in various forms. Alternately, the goods storage 10 may include a plurality of stacks 11 arranged in up and down directions, where the plurality of goods can be stacked horizontally. Each stack 11 is formed with a discharging hole 12 at a lower side thereof, through which the goods can be discharged. The structure of the goods storage 10 and the method of storing and taking out the goods have been known publicly, and thus detailed descriptions thereof will be omitted.

The goods stored in the goods storage 10 include, for example, a coke, a soda pop, a juice, etc., contained in a can or a pack which is hardly ever broken when fallen. However, the goods stored in the goods store 10 are not limited thereto, and may include various kinds of goods such as food like a snack, disposables, or the like, which are also scarcely ever broken when fallen.

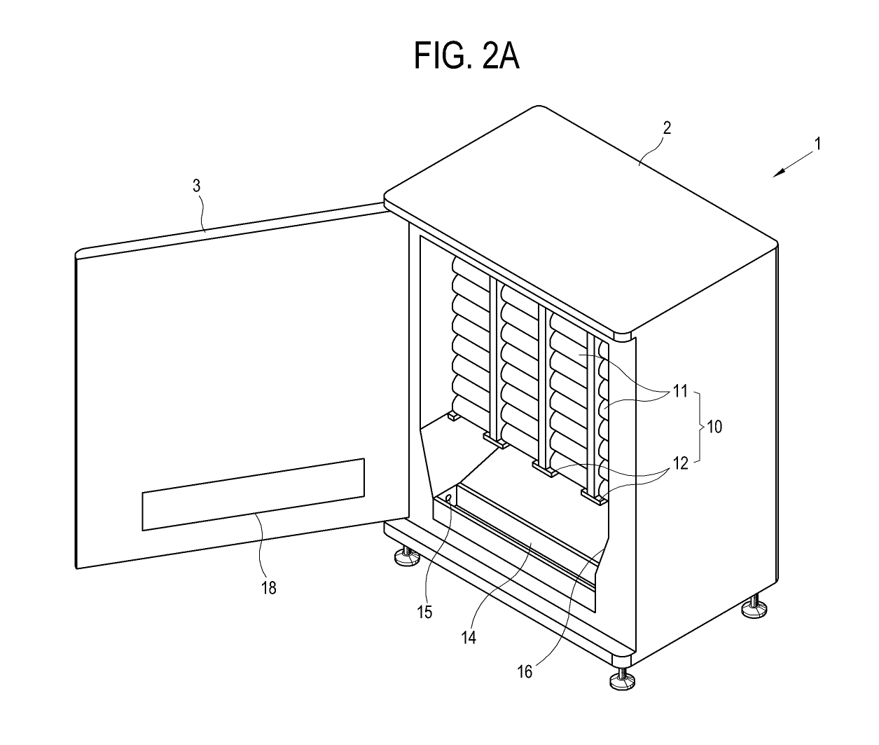

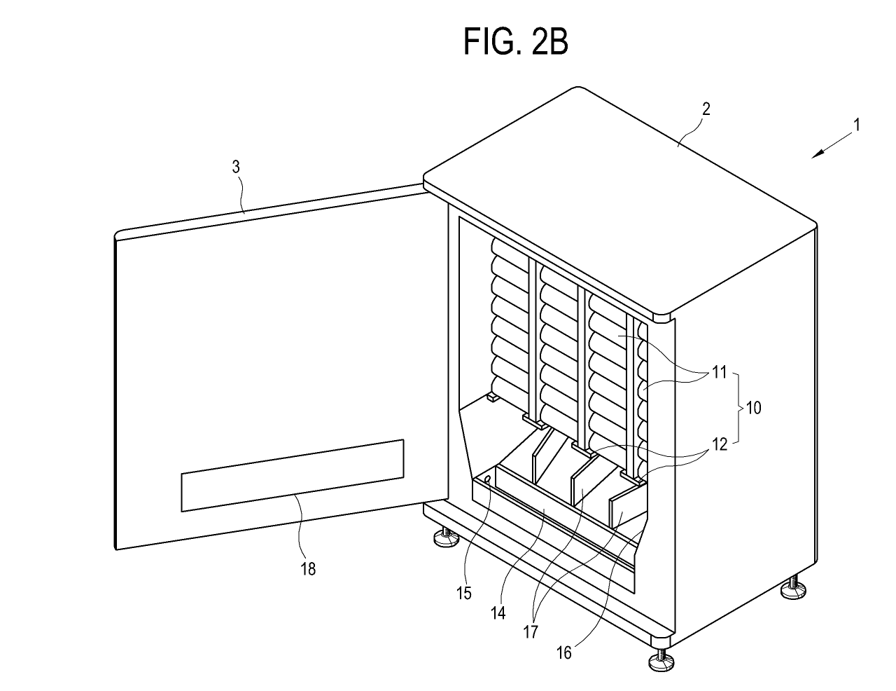

The outlet 14 has a space where the plurality of goods discharged from the goods storage 10 can be accommodated at once. For example, referring to FIGS. 2A and 2B, the discharging hole 12 is so large that the goods discharged from the plural stacks 11 of the goods storage 10 are accommodated therein at the same time. The outlet 14 may includes a taking-out sensor 15 to sense whether or not the goods discharged from the goods storage 10 are taken out through the taking-out opening 18. The taking-out sensor may be achieved by various known sensors such as a pressure sensor or an optical sensor in order to sense whether or not the goods are accommodated in the outlet 14. The taking-out sensor 15 may sense whether the goods are taken out or not under control of the controller 70, and transmit a sensed signal to the controller 70.

Between the outlet 14 and the goods storage 10 is provided a discharging passage 16 to guide the goods from the goods storage 10 to the outlet 14. For example, as shown in FIG. 2A, the discharging passage 16 is provided as a single and large enough to guide the goods discharged from the respective stacks 11 of the goods storage 10 to the outlet 14 at the same time.

According to another exemplary embodiment of the present invention, as shown in FIG. 2B, a plurality of discharging passages 16 may be provided corresponding to the discharging holes 12 of the goods storage 10. That is, for example, the plurality of discharging passages 16 are divided by a plurality of partition walls 17, but not limited thereto. Alternatively, the discharging passages may have various shapes to be divided from one another. Thus, the goods discharged from the plural stacks 11 of the goods storage 10 at the same time are guided to the outlet through the individual discharging passages 16. In this case, the goods are discharged not only at the same time but also without being collided with one another, so that the goods can be more safely guided to the outlet 14.

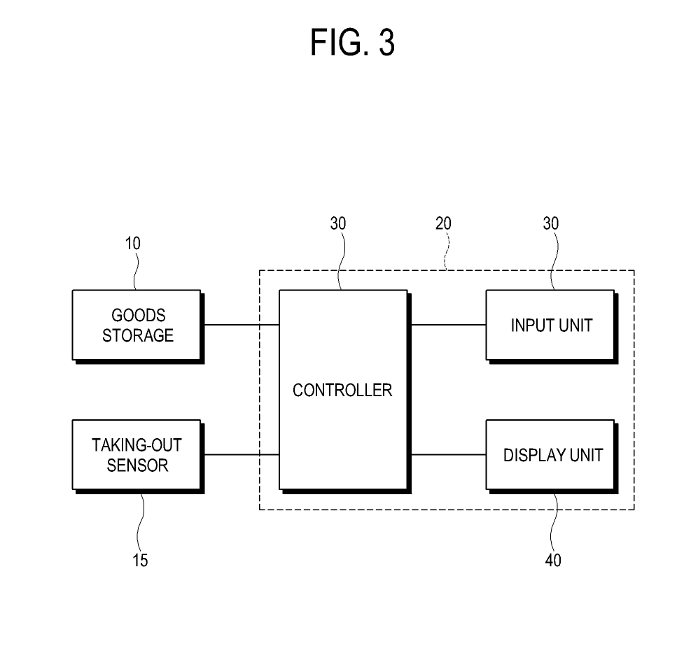

Referring to FIG. 3, a display apparatus 20 according to an exemplary embodiment of the present invention includes the input part 30 to select the plurality of goods to be discharged together, the display unit 40 to display the information and the number of the selected goods, and the controller 70 to control the goods to be discharged from the goods storage 10 to the outlet 14 according to the information and the number of the selected goods.

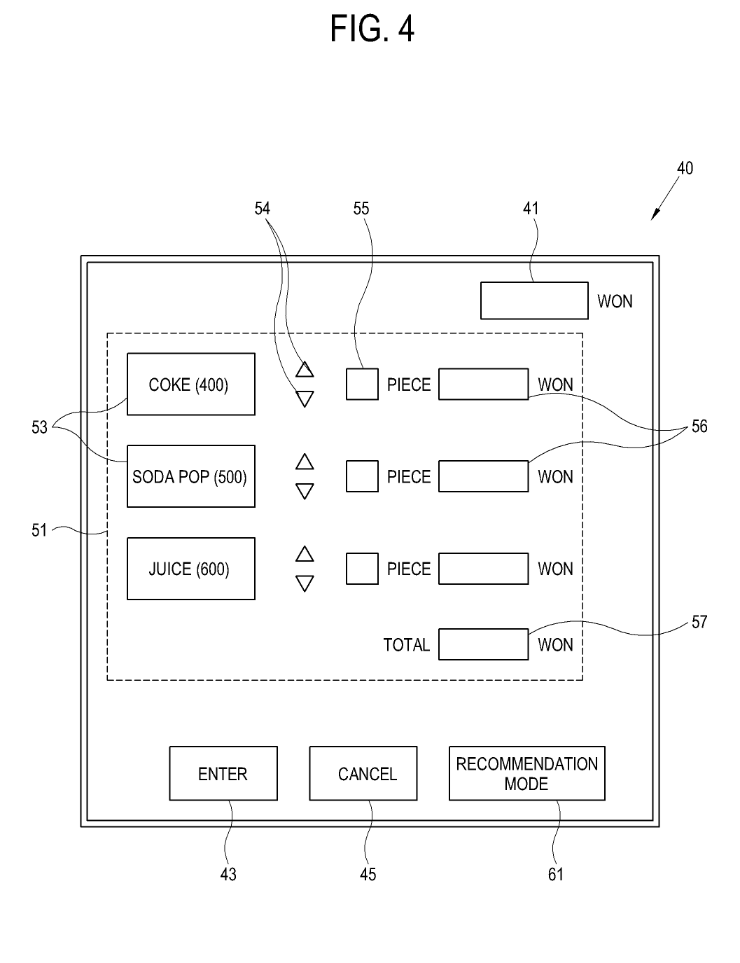

The input part 30 allows a user to select at least one goods. In this embodiment, the input part 30 is provided in the form of a touch panel, in which the touch panel and the display unit 40 are formed as a single body. That is, the input part 30 is realized on the display 40 having a touch-screen function based on the touch panel. As shown in FIG. 4, a user touches a selection menu such as a goods selection menu 53 or the like displayed on the display unit 40 having the touch-screen function, so that he/she can input the kind, the quantity, etc. of the goods. However, the input part 30 is not limited thereto, and alternatively may be provided in various forms such as a button on the door 3, thereby allowing a user to input the kind, the quantity, etc. of the goods.

The plurality of goods selected by the input part may include one kind of goods which are plural. For example, the plurality of goods selected by the input part may include a plurality of cokes. Further, the plurality of goods selected by the input part may include plural kinds of goods, each of which is at least one. Also, the plurality of goods selected by the input part may include plural kinds of goods, each of at least two kinds of which is at least one. For example, the plurality of goods selected by the input part may include at least one of cokes and at least one of soda pops.

The controller 70 controls the goods storage 10 to discharge the goods according to the information and the quantity of the goods selected by a user through the input part 30. According to an exemplary embodiment of the present invention, the controller 70 may control the display unit 40 to display the information, the quantity, etc. of the goods selected by a user. Further, various forms of selection menus may be displayed on the display unit 40 according to a preset program so that a user can easily select the goods. That is, the controller 70 may control the information and the quantity of the goods, the amount of money inserted, etc. displayed on the display unit 40. In this exemplary embodiment, a central processing unit (CPU) having a predetermined memory is used as the controller 70, but not limited thereto. Alternatively, the controller 70 may have a separate memory, and may be achieved by various forms of a microcomputer capable of controlling the goods to be discharged according to the selected information and quantity and controlling the display unit, etc.

According to an exemplary embodiment of the present invention, the information and the quantity of the goods selected by a user are displayed on the display unit 40. In this exemplary embodiment, the display unit 40 includes a flat panel display, i.e., a liquid crystal display (LCD) panel, but not limited thereto. Alternatively, the display unit 40 may be provided in various forms such as a plasma display panel or an organic light emitting diode. The information of the goods displayed on the display unit 40 may include at least one of icons and names corresponding to the goods, but not limited thereto. Alternatively, the information of the goods may include diverse information such as a price, a manufacturer, a caution, etc. In this exemplary embodiment, the display unit 40 and the controller 70 are integrally assembled into the display apparatus 20, and the display apparatus 20 is attached to a front of the door 3.

According to an exemplary embodiment of the present invention, the controller 70 may calculate how many goods can be selected with respect to each of the goods in consideration of the amount of money inserted by a user, control the display unit 40 to display the calculated quantity of goods. Further, in consideration of the amount of money remained after at least one of the goods is selected, the controller 70 may calculate how many goods can be additionally selected and control the display unit to display the calculated quantity of goods.

The display unit 40 displays the information, the quantity, etc. of the goods so that a user can easily select the goods. As shown in FIG. 4, the controller 70 controls the display unit 40 to display a user input mode area 51 so that a user can directly select the plurality of goods. For example, the controller 70 may control the display unit 40 to display a goods selection menu 53 through which a user directly selects the plurality of goods to be discharged, and a quantity setting menu 54 through which a user can set the quantity of the selected goods. The quantity setting menu 54 is provided as a pair to increase and decrease the quantity, but not limited thereto. Alternatively, the quantity setting menu 54 may be provided in various manners. For example, the quantity setting menu 54 may be provided in the form of number buttons as well as arrow buttons as shown in FIG. 4. Without any separate button, the quantity setting menu 54 may allow a user to set the quantity of the selected goods according to how many times the goods on the goods selection menu 53 is touched.

Further, the controller 70 may control the display unit 40 to additionally display at least one of a quantity showing area 55 that shows the quantity set through each quantity setting menu 54, a selection money showing area 56 that shows the amount of money corresponding to the setting quantity of the goods, and a money-sum showing area 57 that shows a sum of respective selection money showing areas 56. Also, the display unit 40 may additionally display an money inserted showing area 41 to display the amount of money inserted, an enter menu 43 to implement the menu selected by a user, and a cancel menu 45 to cancel the selected menu. Thus, a user can select the information about the goods through the goods selection menu 53 and the quantity setting menu 54 of the user input mode area 51 in consideration of the amount of money inserted, and then select the enter menu 43 to discharge the goods to the outlet 14 or the cancel menu 45 to select the goods again.

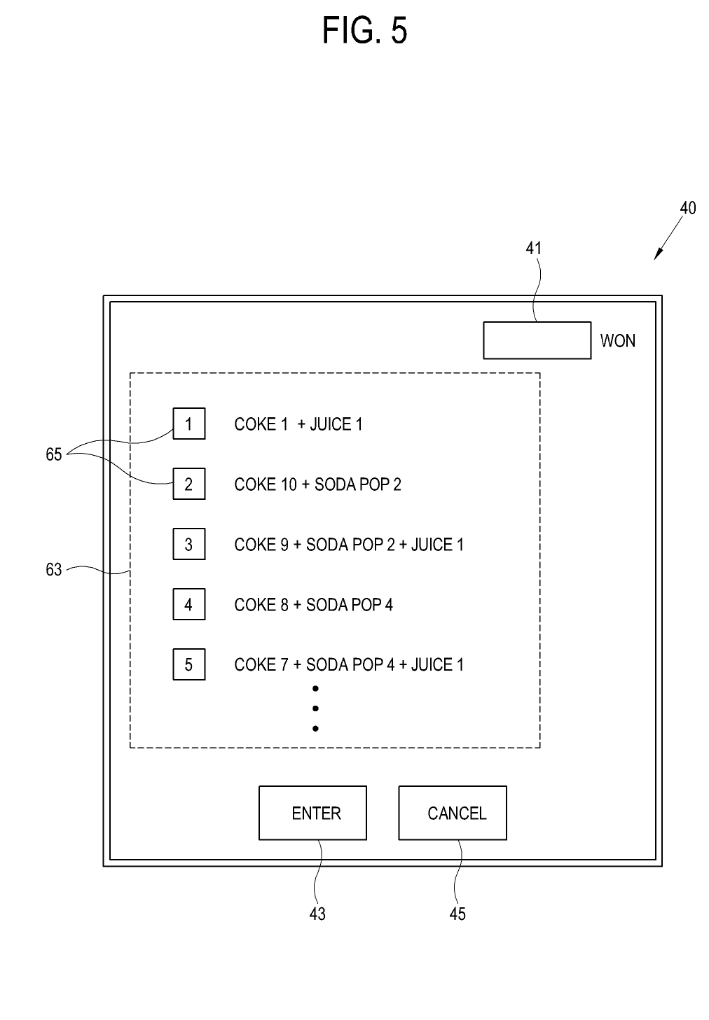

The controller 70 may control the display unit 40 to display a recommendation menu 61 to thereby recommend the goods to a user according to the amount of money inserted by him/her. As shown in FIG. 5, if a user selects the recommendation menu 61, the controller 70 controls the display unit 40 to display a recommendation mode showing area 63 to show a list of recommended goods. For example, the controller 70 may control the display unit 40 to display the list of goods in order of leaving less change with respect to the amount of money inserted. Also, if there are the lists of goods, which leave the same change, among the lists of recommended goods, the controller 70 may determines the respective quantities of goods discharged from the goods storage 10 and displays the list of recommended goods in order of the most discharged goods. For example, as shown in FIG. 5, suppose that the amount of money inserted is 5,000 won, a unit price of a coke is 400 won, a unit price of a soda pop is 500 won, and a unit price of a juice is 600 won, and the most discharged goods are a coke, a soda pop, and a juice in order. Under this condition, the goods are listed in order of the most vended goods while leaving less change. Thus, the first recommendation menu 65 for the list of goods is set to select the most vended goods, i.e., the coke the most while leaving no change, so that eleven cokes and one juice can be listed. The second recommendation menu 65 for the list of goods is set to select the most vended goods, i.e., the coke the next while leaving no change, so that ten cokes and two soda pops can be listed. Likewise, the third and the fourth recommendation menus 65 for the list of goods may be set. The number of recommendation menus 65 for the list of goods is provided enough to make a user to easily select the recommendation menu 65. In the present exemplary embodiment, five recommendation menus 65 for the list of goods are provided. Alternatively, four or less recommendation menus, six or more recommendation menus may be given without being limited to the foregoing exemplary embodiment.

Meanwhile, instead of first considering the order of leaving less change, the controller 70 may determine each amount of goods discharged from the goods storage 10 and then list the goods in consideration of the most discharged goods. Further, if there are the lists of goods, which leave the same change, among the lists of recommended goods, the controller 70 may list the goods according to a preset list of popular goods, or the like.

The controller 70 may limit the quantity of goods, which can be discharged from the goods storage 10 to the outlet 14 at once, among the plural goods selected to be discharged together. According to an exemplary embodiment of the present invention, based on a reference quantity of the goods previously set to be discharged at a time, the controller 70 controls the quantity of goods dischargeable at once to be less than the reference quantity. Here, the plural goods selected to be discharged together refer to the plural goods selected by a user through the input part 30. Further, the quantity of goods to be discharged to the outlet 14 at a time refers to the quantity of goods to be discharged to the outlet 14 among the plural goods selected by a user at a time in consideration of a capacity of the outlet 14, etc. For example, suppose that the plural goods selected by a user to be discharged together are ten cokes. However, if the reference quantity to be discharged to the outlet 14 at once is previously set to six in consideration of the capacity of the outlet 14 or the like, six cokes can be charged to the outlet 14 at once. Thus, in this case, six cokes are first discharged to the outlet 14 at once, and the other four cokes are then discharged to the outlet 14 at once.

According to another exemplary embodiment of the present invention, based on a weighted value preset according to goods and a reference weighted value previously set to discharge the goods at once, the controller 70 may control a total weighted value of goods dischargeable at once to be less than the reference weighted value. For example, the weighted values preset according to the goods are as follows: the coke is ‘1,’ the soda pop is ‘1,’ and the juice is ‘2.’ If the reference weighted value previously set in consideration of the capacity of the outlet 14 is ‘6’ and a user selects five cokes and two juice, the quantity of goods to be discharged to the outlet 14 at once is set to be equal to or less than the reference weighted value and approximate the reference weighted value the most. That is, four cokes and one juice are discharged. After taking out the goods from the outlet 14, the other one coke and one juice are discharged at once. However, the quantity of goods discharged to the outlet 14 at once is not limited to the foregoing exemplary embodiment. Alternatively, the quantity of goods discharged to the outlet 14 at once may be set to be equal to or less than the reference weighted value and satisfy the same kind of goods. Thus, in this case, five cokes are discharged to the outlet 14 at once, and then two juices are discharged at once after the five cokes are taken out from the outlet 14.

With this configuration, the vending machine 1 according to an exemplary embodiment of the present invention allows a user to select the plurality of goods to be discharged together through the input part 30. Thus, the vending machine 1 takes a short time to vend the goods and is convenient for a user as compared with the case that the goods are individually selected.

Further, the vending machine 1 according to an exemplary embodiment of the present invention can discharge at least plural goods to the outlet 14 together among the plural goods selected by a user to be discharged at once. Thus, the vending machine 1 takes a short time to vend the goods and is convenient for a user as compared with the case that the goods are individually discharged.

Also, the vending machine 1 according to an exemplary embodiment of the present invention can limit the quantity of goods to be discharged at once. Thus, it is convenient for a user to take out the goods since too many goods to be discharged at once are prevented in consideration of the capacity of the outlet 14.

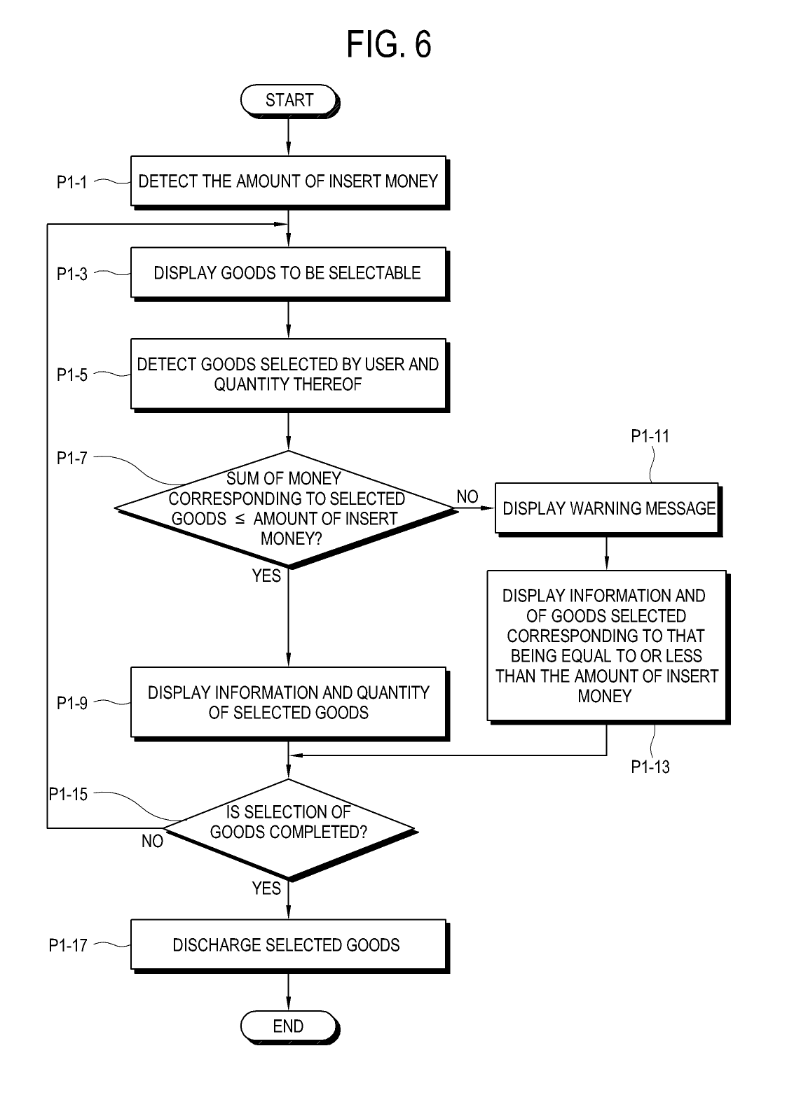

Below, control methods of the vending machine and the display apparatus for the vending machine according to exemplary embodiments of the present invention will be described with reference to FIGS. 6 through 11.

Referring to FIG. 6, the control method of the vending machine according to an exemplary embodiment of the present invention is configured to detect the amount of money inserted by a user (P1-1). In this case, the amount of money inserted by a user can be displayed on the display unit 40 as shown in FIG. 4. Then, the goods to be selectable are displayed (P1-3). Likewise, the goods to be selectable are also displayed on the display unit 40.

Then, the controller 70 determines which and how many goods are selected by a user (P1-5). That is, if a user selects the goods and their quantity, the controller 70 determines the kind of goods selected by a user and the quantity of selected goods.

Then, the controller 70 compares the sum of money corresponding to the selected goods with the amount of money inserted (P1-7). At this time, if the sum of money corresponding to the selected goods is equal to or less than the amount of money inserted, the information and the quantity of plural selected goods are displayed (P1-9). Here, the information and the quantity of the selected plural goods can be displayed on the display unit 40. As shown in FIG. 4, the selected goods, the quantity of the selected goods, the amount of money corresponding to the selected goods, etc. are displayed on the display unit 40. Then, the controller 70 determines whether the selection of the goods is completed (P1-15). For example, after the selection of the goods is completed, a user can select the enter menu 43. However, if a user does not select the enter menu 43 for a predetermined time or select the cancel menu 45, the controller 70 determines the selection of the goods is not completed, and thus returns back to the process P1-3. If the selection of the goods is completed, the selected goods are discharged to the outlet 14 (P1-17).

If the sum of money corresponding to the selected goods is more than the amount of money inserted, a warning message is displayed (P1-11). For example, the warning message informs a user that the sum of money corresponding to the selected goods exceeds the amount of money inserted and the goods cannot be selected any more. Then, the information and the quantity of the goods selected to make the sum of money thereof be less than the amount of money inserted are displayed on the display unit 40 (P1-13). Then, it is determined whether the selection of the goods is completed or not (P1-15), and the following processes are the same as described above so that repetitive descriptions thereof will be omitted. Alternatively, the controller 70 may compare the sum of money corresponding to the selected goods with the amount of money every time when the quantity of goods is selected by a user. When the sum of money corresponding to the selected goods exceeds the amount of money inserted, the controller 70 may control the goods not to be selected while displaying the warning message.

With this control method of the vending machine according to the exemplary embodiment shown in FIG. 6, a user can select the plurality of goods to be discharged all together. Thus, this method takes a short time to vend the goods and is convenient for a user as compared with the case that the goods are individually selected.

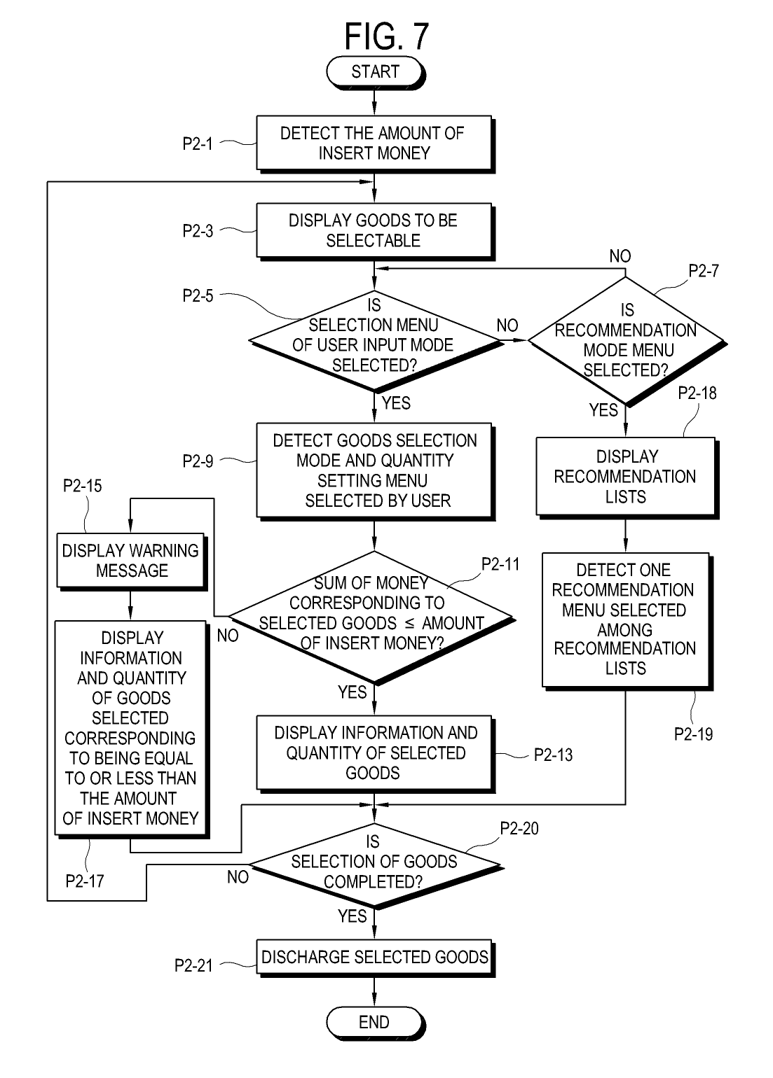

Referring to FIG. 7, the control method of the vending machine according to an exemplary embodiment of the present invention is configured to detect the amount of money inserted by a user (P2-1). In this case, the amount of money inserted by a user can be displayed on the display unit 40 as shown in FIG. 4. Then, the goods to be selectable are displayed (P2-3). Likewise, the goods to be selectable are also displayed on the display unit 40.

Then, the controller 70 determines whether the goods selection menu 53 or the like of the user input mode is selected (P2-5). If the goods selection menu 53 or the like of the user input mode is selected, the controller 70 detects the selection of a user through the goods selection menu 53 and the quantity setting menu 54 (P2-9). That is, if a user selects the goods and their quantity through the goods selection menu 53 and the quantity setting menu 54 of the user input mode, the controller 70 determines the kind of goods selected by a user and the quantity of selected goods.

Then, the controller 70 compares the sum of money corresponding to the selected goods with the amount of money inserted (P2-11). At this time, if the sum of money corresponding to the selected goods is equal to or less than the amount of money inserted, the information and the quantity of plural selected goods are displayed (P2-13). Here, the information and the quantity of the selected plural goods can be displayed on the display unit 40. As shown in FIG. 4, the selected goods, the quantity of the selected goods, the amount of money corresponding to the selected goods, etc. are displayed on the display unit 40. Then, the controller 70 determines whether the selection of the goods is completed (P2-20). For example, after the selection of the goods is completed, a user can select the enter menu 43. However, if a user does not select the enter menu 43 for a predetermined time or select the cancel menu 45, the controller 70 determines the selection of the goods is not completed, and thus returns back to the process P2-3. If the selection of the goods is completed, the selected goods are discharged to the outlet 14 (P2-21).

If the goods selection menu 53 and the like of the user input mode are not selected in the process P2-5, the controller 70 determines whether the recommendation menu 61 is selected (P2-7). In this case, if the recommendation menu 61 is selected, the list of recommendation goods is displayed as shown in FIG. 5 (P2-18). Then, one selected among the recommendation menus 65 is detected (P2-19). That is, if a user selects one from the list of recommendation menus 65, the controller 70 detects the selected recommendation menu 65. Then, it is determined whether the selection of the goods is completed or not (P2-20), and the following processes are the same as described above so that repetitive descriptions thereof will be omitted.

Further, if the sum of money corresponding to the selected goods is more than the amount of money inserted, a warning message is displayed (P2-15). For example, the warning message informs a user that the sum of money corresponding to the selected goods exceeds the amount of money inserted and the goods cannot be selected any more. Then, the information and the quantity of the goods selected to make the sum of money thereof be less than the amount of money inserted are displayed on the display unit 40 (P2-17). Then, it is determined whether the selection of the goods is completed or not (P2-20), and the following processes are the same as described above so that repetitive descriptions thereof will be omitted.

With this control method of the vending machine according to the exemplary embodiment shown in FIG. 7, a user can select the plurality of goods to be discharged together through various manners given through the user input mode and the recommendation mode. Thus, this method takes a short time to vend the goods and is convenient for a user as compared with the case that the goods are individually selected.

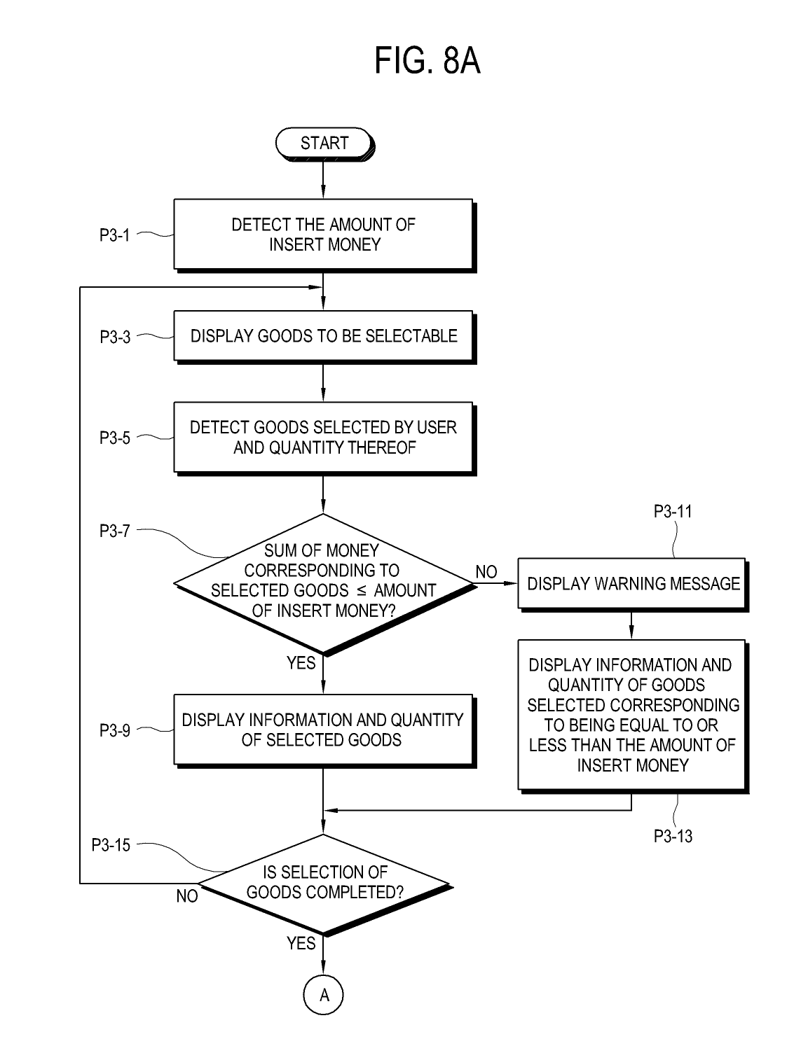

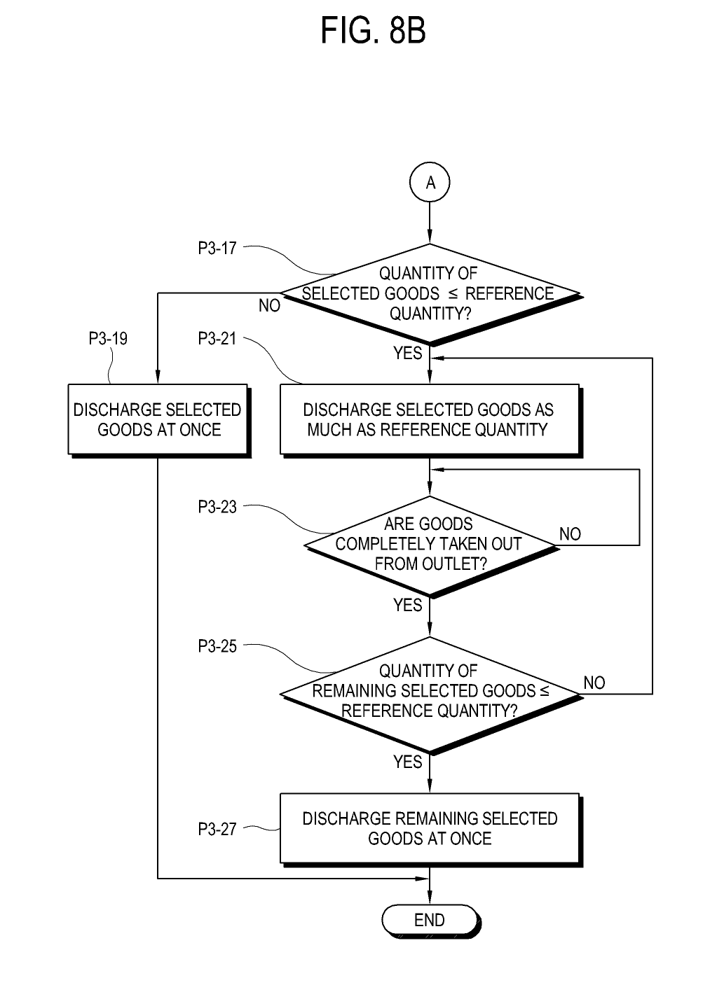

Referring to FIGS. 8A and 8B, the control method of the vending machine according to an exemplary embodiment of the present invention is configured to limit the quantity of goods to be discharged at once in the exemplary embodiment shown in FIG. 6. Here, the processes P3-1 to P3-15 are substantially similar to those shown in FIG. 6, and therefore repetitive descriptions thereof will be avoided.

It is determined whether the selection of the goods is completed or not (P3-15). When the selection of the goods is completed, the controller compares the quantity of the selected goods with the preset reference quantity (P3-17). If the quantity of the selected goods is equal to or less than the preset reference quantity, the selected goods are discharged to the outlet 14 at once (P3-19). If the quantity of the selected goods is more than the preset reference quantity, the selected goods are discharged to the outlet 14 as much as the reference quantity at once (P3-21).

Then, it is determined whether the goods are completely taken out from the outlet 14 (P3-23). If the goods are completely taken out, the remaining quantity of the selected goods is compared again with the reference quantity (P3-25). If the remaining quantity of the selected goods is equal to or less than the preset reference quantity, the remained goods among the selected goods are discharged to the outlet 14 at once (P3-27). On the other hand, if the remaining quantity of the selected goods is more than the preset reference quantity, the controller 70 returns back to the process P3-21 and discharges the remained goods among the selected goods are discharged as much as the reference quantity at once (P3-21). Then, the following processes repeat the foregoing processes.

With this control method of the vending machine according to the exemplary embodiment shown in FIGS. 8A and 8B, a user can select the plurality of goods to be discharged together, in which at least plural goods among the plural selected goods are discharged to the outlet 14 at once, thereby limiting the quantity of goods discharged at once. Thus, this method takes a short time to vend the goods and is convenient for a user as compared with the case that the goods are individually selected. Further, it is convenient for a user to take out the goods since too many goods to be discharged at once are prevented in consideration of the capacity of the outlet 14.

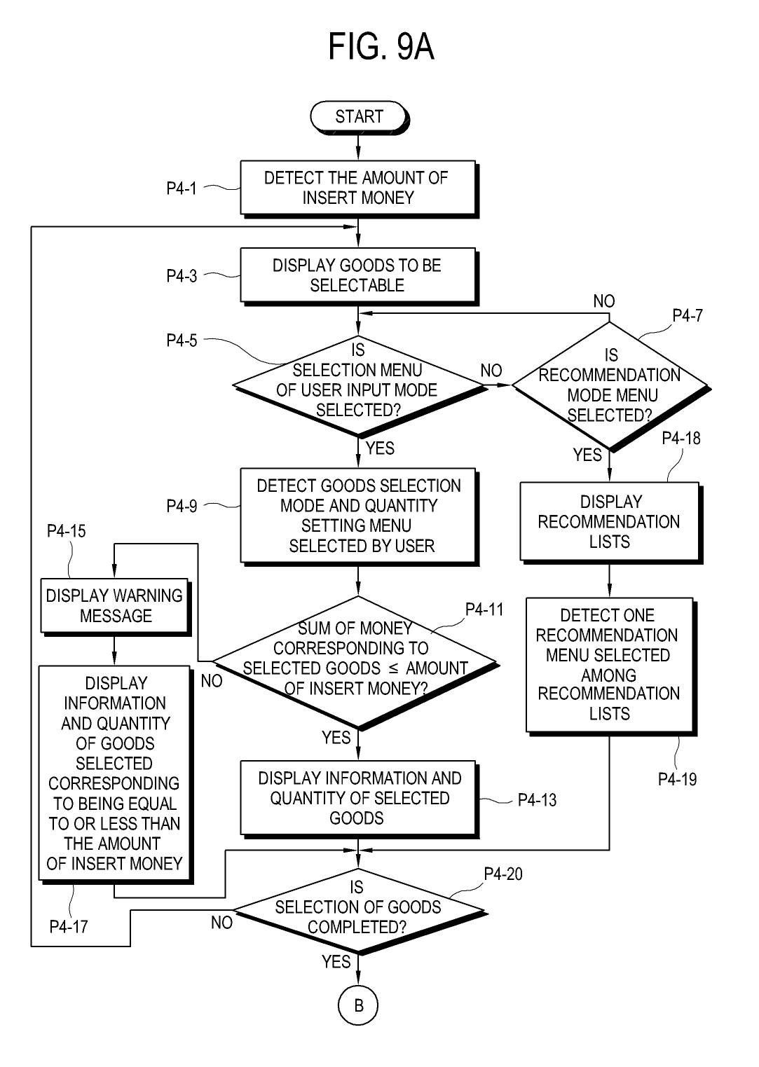

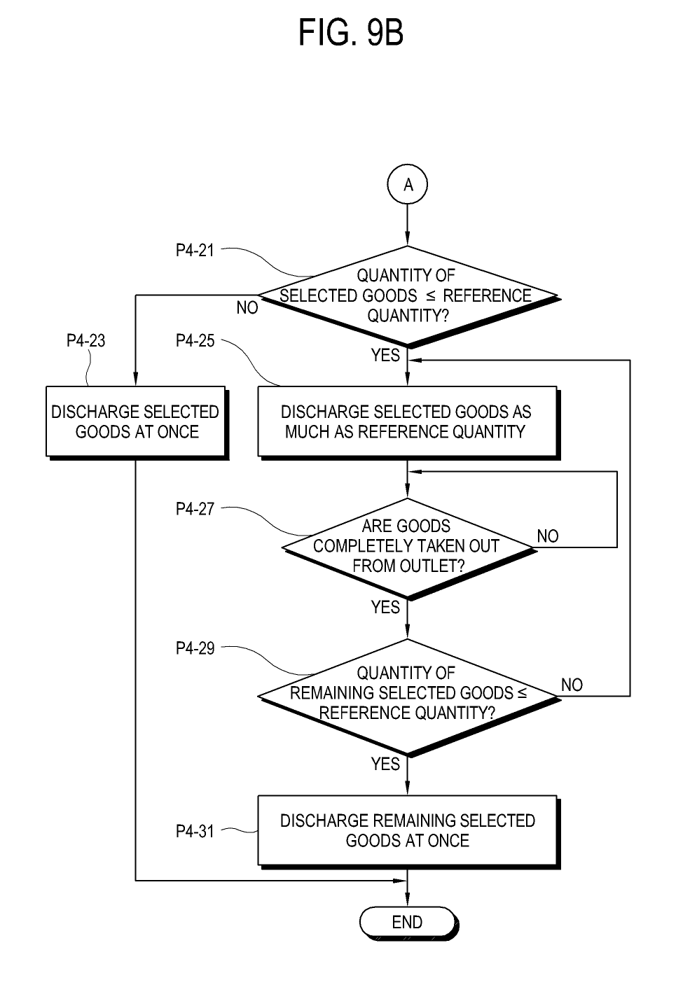

Referring to FIGS. 9A and 9B, the control method of the vending machine according to an exemplary embodiment of the present invention is configured to limit the quantity of goods to be discharged at once by comparing the quantity of goods selected by a user with the preset reference quantity as opposed to the exemplary embodiment shown in FIG. 7. Here, the processes P4-1 to P4-20 are substantially similar to those shown in FIG. 7, and therefore repetitive descriptions thereof will be avoided.

The processes P4-21 to P4-31 are related to limiting the quantity of goods to be discharged at once by comparing the quantity of goods selected by a user with the preset reference quantity, which are substantially similar to the processes P3-17 to P3-27 shown in FIGS. 8A and 8B, and therefore repetitive descriptions thereof will be avoided.

With this control method of the vending machine according to the exemplary embodiment shown in FIGS. 9A and 9B, a user can select the plurality of goods to be discharged together in various manners given through the user input mode and the recommendation mode, in which at least plural goods among the plural selected goods are discharged to the outlet 14 at a time, thereby limiting the quantity of goods discharged at once. Thus, this method takes a short time to vend the goods and is convenient for a user as compared with the case that the goods are individually selected. Further, it is convenient for a user to take out the goods since too many goods to be discharged at once are prevented in consideration of the capacity of the outlet 14.

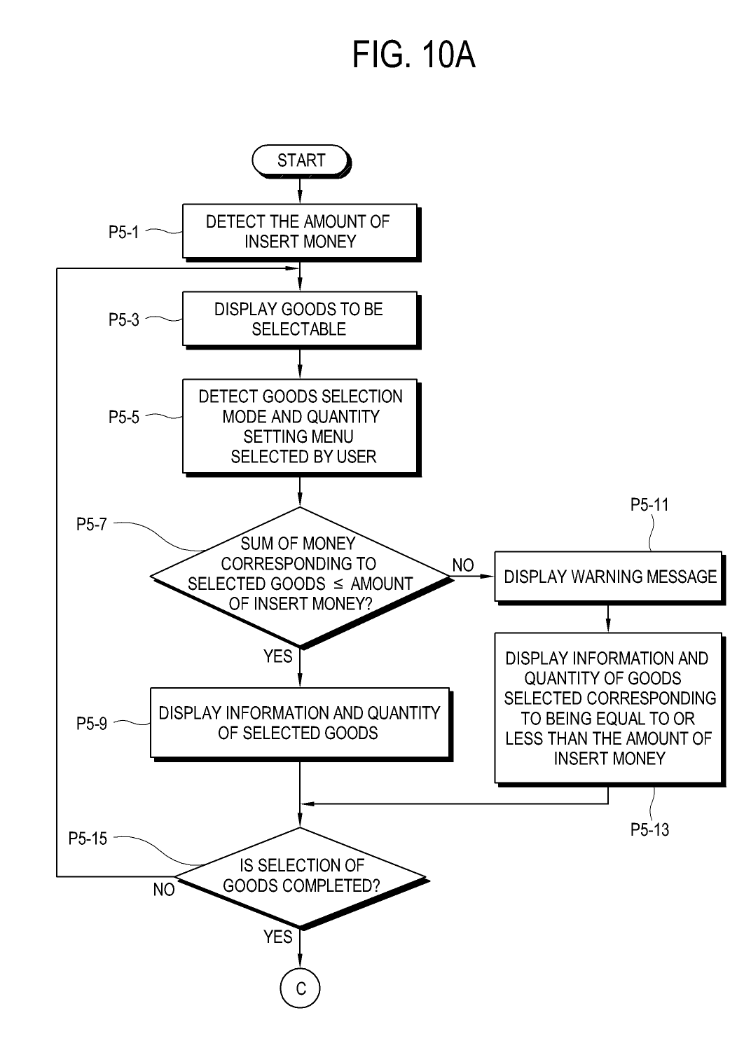

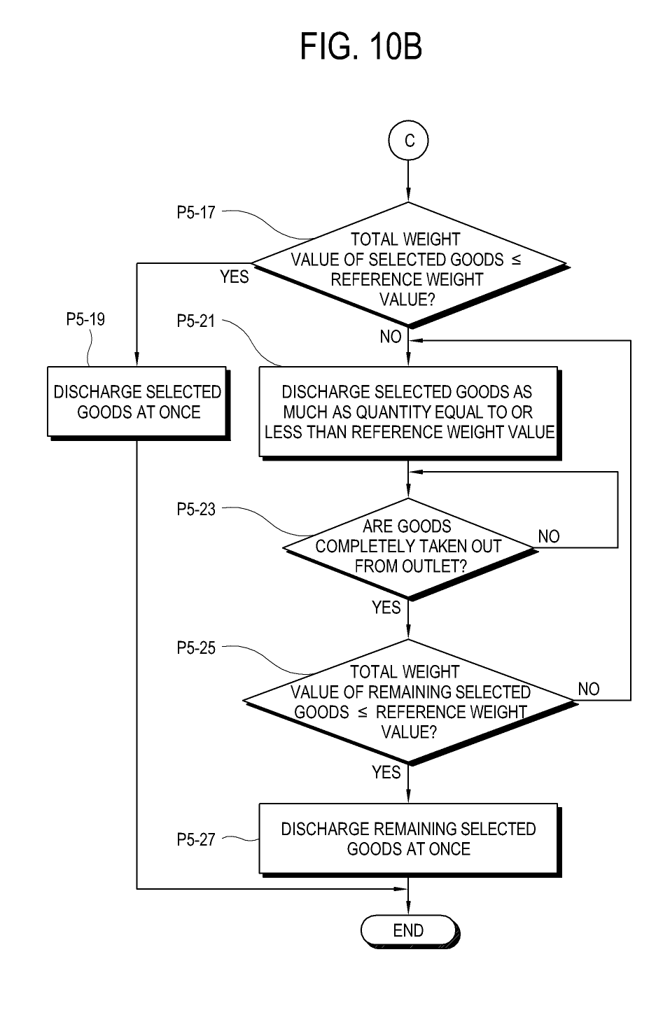

Referring to FIGS. 10A and 10B, the control method of the vending machine according to an exemplary embodiment of the present invention is different from that of the exemplary embodiment shown in FIGS. 8A and 8B in a method of limiting the quantity of goods to be discharged at once. Here, the processes P5-1 to P5-15 are substantially similar to those shown in FIG. 6, and therefore repetitive descriptions thereof will be avoided.

It is determined whether the selection of the goods is completed or not (P5-15). When the selection of the goods is completed, the controller 70 compares the total weighted value of selected goods and the preset reference weighted value based on each preset weighted value of the goods (P5-17). If the total weighted value of the selected goods is equal to or less than the preset reference weighted value, the selected goods are discharged to the outlet 14 at once (P5-19). On the other hand, if the total weighted value of the selected goods is more than the preset reference weighted value, only the quantity of goods equal to or less than the reference weighted value among the selected goods is discharged to the outlet 14 at once (P5-21).

Then, it is determined whether the goods are completely taken out from the outlet 14 (P5-23). If the goods are completely taken out, the total weighted value of the remaining selected goods is compared again with the reference weighted value (P5-25). If the total weighted value of the remaining selected goods is equal to or less than the preset reference weighted value, the remaining selected goods are discharged to the outlet 14 at once (P5-27). On the other hand, if the total weighted value of the remaining selected goods is more than the preset reference weighted value, the controller 70 returns back to the process P5-21 and discharges the remaining selected goods are discharged to the outlet 14 at once as much as the quantity equal to or less than the reference weighted value (P5-21). Then, the following processes repeat the foregoing processes.

With this control method of the vending machine according to the exemplary embodiment shown in FIGS. 10A and 10B, a user can select the plurality of goods to be discharged together, in which at least plural goods among the plural selected goods are discharged to the outlet 14 at a time, thereby limiting the quantity of goods discharged at once. Thus, this method takes a short time to vend the goods and is convenient for a user as compared with the case that the goods are individually selected. Further, it is convenient for a user to take out the goods since too many goods to be discharged at once are prevented in consideration of the capacity of the outlet 14.

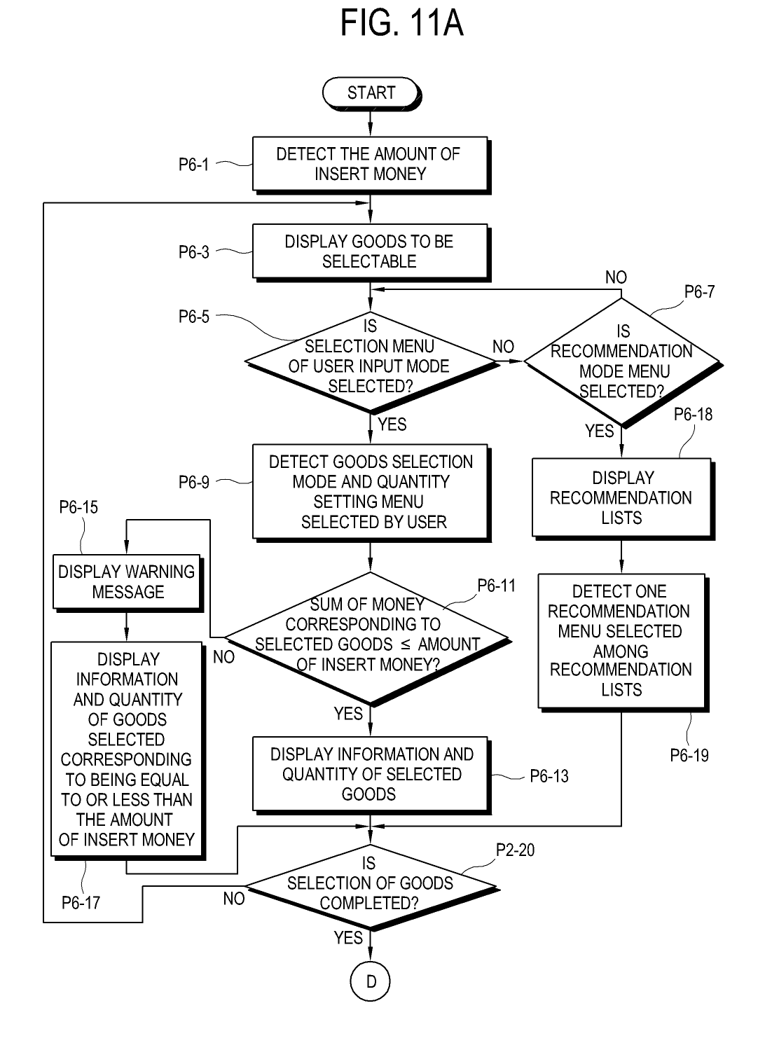

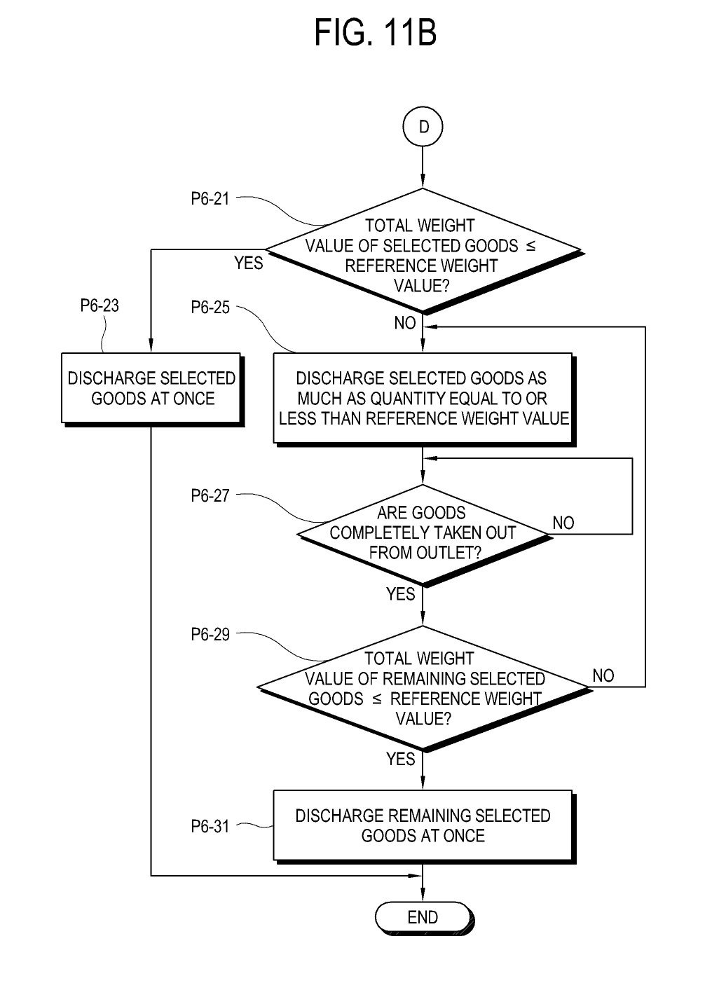

Referring to FIGS. 11A and 11B, the control method of the vending machine according to an exemplary embodiment of the present invention is configured to limit the quantity of goods to be discharged at once by comparing the total weighted value of the goods selected based on each preset weighted value of the goods with the preset reference weighted value as opposed to the exemplary embodiment shown in FIG. 9. Here, the processes P6-1 to P6-20 are substantially similar to those shown in FIG. 7, and therefore repetitive descriptions thereof will be avoided.

Further, the processes P6-21 to P6-31 are related to limiting the quantity of goods to be discharged at once by comparing the total weighted value of the goods selected based on each preset weighted value of the goods with the preset reference weighted value, which are substantially similar to the processes P5-17 to P5-27 shown in FIGS. 10A and 10B, and therefore repetitive descriptions thereof will be avoided.

With this control method of the vending machine according to the exemplary embodiment shown in FIGS. 11A and 11B, a user can select the plurality of goods to be discharged together through various manners given through the user input mode and the recommendation mode, in which at least plural goods among the plural selected goods are discharged to the outlet 14 at a time, thereby limiting the quantity of goods discharged at once. Thus, this method takes a short time to vend the goods and is convenient for a user as compared with the case that the goods are individually selected. Further, it is convenient for a user to take out the goods since too many goods to be discharged at once are prevented in consideration of the capacity of the outlet 14.

As described above, an exemplary embodiment of the present invention provides a display apparatus for a vending machine, a vending machine and a control method with the same, in which a plurality of goods can be selected to be discharged together with one another.

Further, a plurality of goods can be discharged at a time.

Also, a quantity of goods to be discharged at a time can be limited.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display apparatus for a vending machine that has a goods storage to store a plurality of goods, and an outlet to discharge selected goods which are selected from the plurality of goods in the goods storage, the display apparatus comprising:
an input part through which the selected goods are selected to be discharged together;
a display unit which displays information and quantity of the selected goods; and
a controller which controls the goods storage to discharge the selected goods to the outlet based on the information and the quantity of the selected goods.

2. The display apparatus according to claim 1, wherein the controller controls the display unit to display a goods selection menu to select the selected goods to be discharged, and a quantity setting menu to set the quantity of the selected goods selected through the goods selection menu.

3. The display apparatus according to clam 2, wherein the controller controls the display unit to display a recommendation menu for recommending suggested goods from the plurality of goods according to an amount of money inserted.

4. The display apparatus according to claim 3, wherein in the recommendation menu, the controller controls the display unit to display a list of goods from the plurality of goods in order of leaving less change with respect to the amount of money inserted.

5. The display apparatus according to claim 1, wherein the controller limits a discharge quantity of the selected goods to be discharged together, which can be discharged from the goods storage to the outlet at once.

6. The display apparatus according to claim 5, wherein, based on a reference quantity of goods to be discharged at once, the controller controls the discharge quantity of the selected goods to be discharged at once to be equal to or less than the reference quantity.

7. The display apparatus according to claim 5, wherein, based on a weighted value for each good of the plurality of goods, and a reference weighted value for a total quantity of goods to be discharged at once, the controller controls a total weighted value of the selected goods to be dischargeable at once to be equal to or less than the reference weighted value.

8. The display apparatus according to claim 1, wherein the information of the selected goods comprises at least one of icons and names corresponding to the selected goods.

9. The display apparatus according to claim 1, wherein the display unit comprises a flat panel display, and the input part comprises a touch panel.

10. The display apparatus according to claim 9, wherein the display unit and the input part are formed as a single body.

11. The display apparatus according to claim 1, wherein the selected goods selected by the input part comprise a plurality of one kind of good.

12. The display apparatus according to claim 1, wherein the selected goods selected by the input part comprise at least one from each of plural kinds of goods.

13. The display apparatus according to claim 1, wherein the controller calculates a purchasable quantity of goods which can be selected, with respect to each of the goods of the plurality of goods, in consideration of an amount of money inserted, and controls the display unit to display the purchasable quantity of goods calculated by the controller.

14. The display apparatus according to claim 13, wherein the controller calculates a remainder quantity of goods which can be additionally selected, in consideration of an amount of money remaining after at least one of the goods is selected.

15. A vending machine comprising:
a goods storage which stores a plurality of goods;
an outlet which discharges selected goods, selected from plurality of goods, from the goods storage;
an input part through which the selected goods are selected to be discharged together;
a display unit which displays information and quantity of the selected goods; and
a controller which controls the goods storage to discharge the selected goods to the outlet based on the information and the quantity of the selected goods.

16. The vending machine according to claim 15, wherein the controller controls the display unit to display a goods selection menu to select the selected goods to be discharged, and a quantity setting menu to set the quantity of the selected goods selected through the goods selection menu.

17. The vending machine according to claim 15, further comprising a discharging passage which is provided between the goods storage and the outlet and through which the selected goods are discharged at once.

18. The vending machine according to claim 15, further comprising a plurality of discharging passages which are provided between the goods storage and the outlet and through which the selected goods are discharged at once.

19. The vending machine according to claim 15, wherein the information of the selected goods comprises at least one of icons and names corresponding to the selected goods.

20. The vending machine according to claim 15, wherein the display comprises a flat panel display, and the input part comprises a touch panel.

21. The vending machine according to claim 15, wherein the display unit and the input part are formed as a single body.

22. The vending machine according to claim 15, wherein the selected goods selected by the input part comprise a plurality of one kind of good.

23. The vending machine according to claim 15, wherein the selected goods selected by the input part comprise at least one from each of plural kinds of goods.

24. The vending machine according to claim 15, wherein the controller calculates a purchasable quantity of goods which can be selected, with respect to each of the goods of the plurality of goods, in consideration of an amount of money inserted, and controls the display unit to display the purchasable quantity of goods calculated by the controller.

25. A method of controlling a display apparatus for a vending machine that has a goods storage to store a plurality of goods, and an outlet to discharge selected goods from the goods storage, the method comprising:
displaying the plurality of goods, wherein the plurality of goods are selectable;
selecting the selected goods to be dischargeable together;
displaying information and quantity of the selected goods; and
controlling the goods storage to discharge the selected goods to the outlet based on the information and the quantity of the selected goods.

26. The method according to claim 25, further comprising displaying a goods selection menu to select the selected goods to be discharged, and a quantity setting menu to set the quantity of the selected goods selected through the goods selection menu.

27. The method according to clam 26, further comprising displaying a recommendation menu for recommending suggested goods from the plurality of goods according to an amount of money inserted.

28. The method according to claim 27, further comprising displaying a list of goods from the plurality of goods in order of leaving less change with respect to the amount of money inserted, in the recommendation mode menu.

29. The method according to claim 28, further comprising detecting a total quantity of discharged goods discharged from the goods storage, and displaying the discharged goods listed in order of most discharged, if the list of goods includes selectable goods which leave a same amount of change.

30. The method according to claim 25, further comprising limiting a discharge quantity of the selected goods to be discharged together, which can be discharged from the goods storage to the outlet at once.

31. The method according to claim 30, further comprising controlling the discharge quantity to be equal to or less than a reference quantity based on the reference quantity of goods to be discharged at once.

32. The method according to claim 30, further comprising controlling a total weighted value of the selected goods to be dischargeable at once to be equal to or less than a reference weighted value based on a weighted value for each good of the plurality of goods, and the reference weighted value for a total quantity of goods to be discharged at once.

33. A method of controlling a vending machine with a display unit having a touch-screen function, the method comprising:
displaying a plurality of goods, wherein the plurality of goods are selectable;
selecting selected goods to be dischargeable together;
displaying information and quantity of the selected goods; and
controlling the selected goods to be discharged from the goods storage to the outlet based on the information and the quantity of the selected goods.

34. The method according to claim 33, further comprising displaying a goods selection menu to select the selected goods to be discharged, and a quantity setting menu to set the quantity of the selected goods selected through the goods selection menu.
